(19) United States
(12) Patent Application Publication
(10) Pub. No.: US 2015/0268150 A1
(43) Pub. Date: Sep. 24, 2015

(54) LARGE AREA MEMBRANE EVALUATION APPARATUSES AND METHODS FOR USE THEREOF

(71) Applicant: LOCKHEED MARTIN CORPORATION, Bethesda, MD (US)

(72) Inventors: Mark C. NEWKIRK, Moorestown, NJ (US); Sean Martin BALBIRER, Turnersville, NJ (US); Steven M. MOODY, Middle River, MD (US); David B. TUROWSKI, Palmyra, NJ (US)

(21) Appl. No.: 14/667,511

(22) Filed: Mar. 24, 2015

Related U.S. Application Data
(60) Provisional application No. 61/969,724, filed on Mar. 24, 2014.

(51) Int. Cl. G01N 15/08

(52) U.S. Cl. CPC G01N 15/082; G01N 2015/084

(57) ABSTRACT

Permeable materials, such as perforated grapheme and other two-dimensional materials, can be used in filtration applications. However, there are presently no effective testing apparatuses or techniques to determine if a particular permeable material or other membrane is suitable for a given filtration process. Determining concentration polarization in a cross-flow filtration configuration can be especially difficult. Apparatuses disclosed herein for evaluating permeable materials, particularly perforated two-dimensional materials, in filtration membranes can include a flow channel, such as a lateral flow channel, in fluid communication with a membrane containing a permeable material, a porous substrate supporting the permeable material, and a plurality of fluid collection ports disposed laterally with respect to the flow channel. The fluid collection ports are disposed on the side of the permeable material that is opposite the flow channel. Other membranes can also be evaluated with the described apparatuses.

### CROSS-REFERENCE TO RELATED APPLICATIONS

This application claims the benefit of U.S. Provisional Application 61/969,724, filed Mar. 24, 2014, which is hereby incorporated by reference in its entirety.

### STATEMENT REGARDING FEDERALLY SPONSORED RESEARCH OR DEVELOPMENT

Not applicable.

### FIELD

The present disclosure generally relates to filtration, and, more specifically, to apparatuses and methods for evaluation of filters and other membranes.

### BACKGROUND

Molecular filtration refers to processes directed to separation of individual molecules of a substance from a mixture. Such processes are often based upon passing the molecules of the substance through apertures in a separation membrane, where the apertures are of a suitable size to allow individual desired molecules to pass therethrough in preference to undesired molecules that are larger in size and cannot traverse the apertures. Differential diffusion rate membranes are also very prevalent in the marketplace and may function in a related manner. Desalination processes represent one illustrative area in which molecular filtration processes, particularly differential diffusion processes, can be particularly advantageous.

A number of two-dimensional materials can be perforated with a plurality of apertures to allow the passage of appropriately sized molecules therethrough. Graphene represents but one example of a two-dimensional material that can be used in molecular filtration applications. Graphene constitutes an atomically thin layer of carbon in which the carbon atoms reside as closely spaced atoms at regular lattice positions. Synthesizing graphene in a regular lattice is difficult due to the irregular occurrence of defects in as-synthesized two-dimensional materials. Such defects will also be equivalently referred to herein as “apertures,” “perforations,” or “holes.” Apertures can also be introduced intentionally or unintentionally following the synthesis of graphene, including during its removal from a growth substrate and handling thereafter. Illustrative techniques for intentionally perforating graphene can include plasma treatment, particle bombardment, and the like. The term “perforated graphene” will be used herein to denote a graphene sheet with defects in its basal plane, regardless of whether the defects are natively present or intentionally produced.

Although perforated graphene and other two-dimensional materials can allow molecular filtration to take place, presently available perforation processes can sometimes be fairly non-selective. That is, the perforation processes can produce too many or too few perforations, or perforations outside a desired size range can be formed. Due to their small size and the accompanying difficulties of handling and evaluating nanoscale materials, it can often be difficult to determine if a perforated two-dimensional material is suitable for conducting a particular separation process. Presently available membrane evaluation apparatuses are not believed to be fully capable of evaluating perforated two-dimensional materials or other membranes, particularly over large membrane evaluation areas and especially in regard to performance changes that occur laterally across the membrane during cross-flow filtration. The deficiency of present membrane evaluation apparatuses do not allow timely and reliable performance predictions to be made. More particularly, state of the art systems do not allow bulk salinity rise and concentration polarization effects to be accurately measured and performance predictions made.

Although the foregoing issues can be especially prevalent during the evaluation of molecular filters and other types of permeable membranes, membranes configured for conducting traditional filtration processes are believed to be similarly limited by the deficiencies of existing testing protocols. Large area filtration membranes, particularly those extending over a significant lateral length, are not believed to be suitably evaluated by existing testing techniques.

In view of the foregoing, improved apparatuses and methods for evaluating permeable materials and other membranes, particularly those extending over a large area, would be of considerable benefit in the art. The present disclosure satisfies this need and provides related advantages as well.

### SUMMARY

In various embodiments, the present disclosure describes apparatuses and methods that can be used to determine the cross-flow filtration characteristics of permeable materials and other membranes, particularly perforated two-dimensional materials, such as perforated graphene. The apparatuses and method of the invention are capable of evaluating membrane materials over an extended length. In embodiments, the length of the membrane is from 0.30 m to 5 m or from 0.45 m to 1 m. In an embodiment, the membrane characteristics are evaluated at several positions along the length of the membrane.

Use of the apparatuses and methods described herein can allow the performance suitability of a particular permeable material to be determined. In illustrative embodiments, concentration polarization under cross-flow filtration conditions can be determined. In addition, it can be determined if the permeable material has apertures in the correct number and size to carry out a particular filtration process, such as a molecular filtration process. In addition, the apparatuses described herein can facilitate quantification of membrane filtration performance as a function of many variables, such as, for example, salinity, total dissolved solids (TDS), crossflow velocity, turbulence, spacer geometry, flow channel geometry, pressure, membrane configuration, concentration increase, salinity increase, and concentration polarization. Further, the described apparatuses can be used to evaluate membrane effective performance, permeate volume and permeate quality, as a function of lateral position along the length of the membrane, yielding insight into elusive phenomena such as concentration polarization and the effectiveness of feed turbulence in optimizing membrane performance. Element level performance can also be determined using the described apparatuses. Fouling along the flow pathway within the apparatuses can also be monitored.

In an embodiment, the apparatuses include a flow channel, such as a lateral flow channel, proximate to the permeable material or membrane and a plurality of collection ports disposed substantially perpendicular with respect to the flow channel on the opposite side of the permeable material. The plurality of collection ports can be disposed laterally with respect to the permeable material on the opposite side of the permeable material.

In a further embodiment, the invention provides a cross-flow filtration membrane test apparatus for testing at least one membrane, the apparatus comprising a feed inlet, a feed outlet, a plurality of permeate collection ports and a plurality of permeate outlets. The apparatus is configured to form a flow channel with a first face of the membrane during testing of the membrane, the first face of the membrane comprising a portion of the surface of the flow channel over a length of the membrane. The flow channel is fluidically connected to the feed inlet and the feed outlet. In an embodiment, one end of the flow channel is fluidically connected to the feed inlet and the other end of the flow channel is fluidically connected to the feed outlet. The permeate collection ports are disposed along the length of the membrane and on the same side as a second face of the membrane and each permeate outlet is fluidically connected to at least one permeate collection port. In an embodiment, the apparatus further comprises a porous membrane support for supporting the second face of the membrane. In an embodiment, the apparatus further comprises a cavity for receiving the porous membrane support, the permeate collection ports being disposed along the length of the cavity. In embodiments, the number of permeate outlets is from 2 to 100, from 5 to 10, or from 10 to 25. In an embodiments, the number of permeate collection ports fluidically connected to each of the permeate outlets is an integer from 1 to 25, from 1 to 10, or from 1 to 5, or from 5 to 10.

FIG. 1A schematically illustrates an exemplary apparatus 10; FIG. 1B is a cross-sectional view of a portion of the apparatus in FIG. 1A. as indicated by the dotted lines. Neither FIGURE lA nor FIG. 1B is to scale; certain elements have been enlarged for clarity. FIG. 1B illustrates feed inlet 30 and flow channel 34. In an embodiment, the top face of the membrane 15 forms at least a portion of the bottom surface of the flow channel 34, as seen in FIG. 1B. In use of the apparatus flow of a feed fluid proceeds from the feed inlet into the flow channel, as indicated by the arrows, establishing cross-flow across membrane 15. In this configuration, fluid that permeates through the membrane also permeates through the porous membrane support 16, which is in contact with the opposite face of the membrane. The permeate subsequently enters the permeate collection ports 20 which are disposed laterally along the membrane, allowing collection of separate permeate flows from different locations along the membrane. In an embodiment, the permeate may proceed from a collection port 20 into a collection well 21 and then into permeate channel 22 before proceeding to a permeate outlet 26. Measurement of analysis of the fluid collected from each of the permeate outlets allows determination of membrane properties as a function of distance along the membrane.

The apparatus embodiment shown in FIGS. 1A and 1B also includes several other features. The feed insert 12, also referred to as a flow channel insert herein, comprises the feed inlet and feed outlet in this embodiment. The feed insert also forms at least a portion of the surface of the flow channel. Optional shoe insert 13, also referred to as a channel height shoe herein, forms at least a portion of the top surface of flow channel 34 when present, as shown in FIG. 1B. In embodiments where the optional shoe insert is not present, the flow channel insert provides at least a portion of the top surface of the flow channel. The shoe insert is removable; inserts of different heights can be used to establish different flow channel heights. The shoe insert may be attached by connectors 52 inserted through openings 42a, also shown in FIG. 1A. This connection may be sealed with an O-ring (not shown in FIG. 1B, please refer to FIG. 2D a).

In the embodiment shown in FIG. 1A and 1B, the apparatus further comprises a base 17 and a lid body 11. An O-ring 14, acts as a sealing element between the membrane and feed insert 12. Optional alignment pin 57 is provided to align base 17 and feed insert 12; the membrane 15 may be notched so that the alignment pin fits through the notch. Additional connecting elements, not shown in FIGS. 1A and 1B, are used to hold the assembled layers of the apparatus in place. Openings 44a for insertion of these connection elements are shown in FIG. 1A. As shown in FIG. 1B, the base 17 may comprise a recess or cavity in which the porous membrane support is placed, the permeate collection ports are disposed along the inner surface of this cavity. Support pins 18 may also be placed across the permeate collection ports to help support the porous membrane support.

In an embodiment, the invention provides a cross-flow filtration membrane test apparatus comprising
a. a lid body comprising an outer and an inner surface;
b. a feed insert comprising a first end and a second end, the feed inlet being located at the first end of the feed insert, the feed outlet being located at the second end of the feed insert, an outer surface and an inner surface, the outer surface of the feed insert contacting the inner surface of the lid body during testing of the membrane;
c. a shoe insert comprising an outer surface and an inner surface, the outer surface of the shoe insert connected to the inner surface of the feed insert during testing of the membrane and the inner surface of the shoe insert forming a portion of the flow channel during testing of the membrane;
d. a base comprising an outer surface and an inner surface, the inner surface of the base comprising a cavity for receiving a porous membrane support the cavity having a length and the interior surface of the cavity further comprising the plurality of permeate collection ports disposed along the length of the cavity, and the base further comprising the plurality of permeate outlets;
e. a sealing element disposed between the feed insert and the base during testing of the membrane; and
f. a plurality of connecting elements for holding the lid body, the feed insert and the base in place during testing of the membrane.
   The apparatus may be disassembled, such as for insertion or changing of the membranes. Therefore the flow channel may only be formed and some elements of the apparatus may only be connected when the apparatus is assembled and/or during testing of the membrane.

In a further embodiment, the invention provides a cross-flow filtration membrane test apparatus which does not include a shoe insert, the apparatus comprising
a. a lid body comprising an outer and an inner surface;
b. a feed insert comprising a first end and a second end, the feed inlet being located at the first end of the feed insert, the feed outlet being located at the second end of the feed insert, an outer surface and an inner surface, the inner surface of the shoe insert forming a portion of the flow channel and the outer surface of the feed insert contacting the inner surface of the lid body during testing of the membrane;
c. a base comprising an outer surface and an inner surface, the inner surface of the base comprising a cavity for receiving a porous membrane support, the cavity having a length and the interior surface of the cavity further comprising the plurality of permeate collection ports disposed along the length of the cavity, and the base further comprising the plurality of permeate outlets;
d. a sealing element disposed between the feed insert and the base during testing of the membrane; and
e. a plurality of connecting elements for holding the lid body, the feed insert and the base in place during testing of the membrane.

In a further embodiment, the base of the apparatus comprises a permeate insert and a base body. FIGS. 2B-2D illustrate an exemplary permeate insert and base body. As can be seen in FIG. 2B, the permeate insert comprises the cavity 19 for the porous membrane support. FIG. 2B also shows a top view illustrating support pins 18 which are longer than the width of the collection ports; the ends of the support pins may be inserted into grooves in the permeate insert. In an embodiment, a plurality of permeate collection ports are fluidically connected to a permeate insert outlet 23. As shown in FIG. 2D the outlet portion of the permeate insert may extend into through-hole in the base body; in this embodiment a given permeate insert outlet is in fluid communication with one permeate outlet. In a further embodiment, a plurality of permeate insert outlets are connected to one permeate outlet.

In an embodiment, the invention provides a cross-flow filtration membrane test apparatus comprising
a. a lid body comprising an outer and an inner surface;
b. a feed insert comprising a first end and a second end, the feed inlet being located at the first end of the feed insert, the feed outlet being located at the second end of the feed insert, an outer surface and an inner surface, the outer surface of the feed insert contacting the inner surface of the lid body during testing of the membrane;
c. a shoe insert comprising an outer surface and an inner surface, the outer surface of the shoe insert connected to the inner surface of the feed insert during testing of the membrane and the inner surface of the shoe insert forming a portion of the flow channel during testing of the membrane;
d. a base comprising;
i. a permeate insert comprising an outer surface and an inner surface, the inner surface of the permeate insert comprising a cavity for receiving a porous membrane support, the cavity having a length and the interior surface of the cavity further comprising a plurality of permeate collection ports disposed along the length of the cavity and the outer surface of the permeate insert comprising a plurality of permeate insert outlets, each of the permeate insert outlets being fluidically connected to at least one of the permeate collection ports;
ii. a base body comprising an outer surface and an inner surface and the permeate outlets, the inner surface of the base body being in contact with to the outer surface of the permeate insert and each of the permeate outlets being fluidically connected to at least one of the permeate insert outlets during testing of the membrane
e. a sealing element disposed between the feed insert and the permeate insert during testing of the membrane; and
f. a plurality of connecting elements for holding the lid body, the feed insert and the base in place during testing of the membrane.

In further embodiments, electrical connections are provided to elements of the apparatus. The electrical connections can allow establishment of an electrical voltage difference or current gradient across the flow field. One potential may be established along the flow path or the potential may be segmented in sections. In embodiments, the electrical connections are connected to a signal source capable of supplying constant or varying (e.g. in the form of a waveform) current or voltage. In an embodiment, the shoe insert and the membrane are electrically conducting, and the base and feed insert are electrically insulating. A first electrical connection may be provided to the shoe insert (e.g. through connector 52) and a second electrical connection may be made to the membrane (e.g. through a thin conductive element connected to the portion of the membrane extending beyond alignment pin 57). In a further embodiment, the shoe insert and the membrane are electrically conducting, the permeate insert and the feed insert are electrically insulating and the apparatus further comprises a first electrical contact to the shoe insert and a second electrical contact to the membrane. For example, the permeate insert and feed insert may be made of a polymeric or plastic material. Suitable polymeric materials for the permeate insert include, but are not limited to acetal polymers, also known as polyacetal, polyoxymethylene (POM), or polyformaldehyde. Acetal polymers include Dekin®, an acetal homopolymer. In an alternate embodiment when the permeate insert is not present, the base is conducting instead of insulating and the bottom electrical connection is made to the base. In configurations when two membranes surround a flow channel (face-to-face), both membranes may be conducting and an electrical connection is provided to each. In other embodiments when non-conductive membranes are used, additional sheets of conductive material may be placed either behind or in front of the membrane to be tested to act as an electrode. The electrical connection(s) is/are then made to these sheets of material. These sheets of conductive material may be permeable as needed (e.g. a perforated or woven conductive sheet). In an embodiment, one or more conductive elements are buffered by non-reactive conductive carbon fibers or nanotubes to eliminate battery reactions or oxy-redox reactions.

In an embodiment, each permeate outlet is in fluidically connected to a permeate measurement device. Suitable measurement devices known to the art include devices for measuring weight of permeate fluid, flow meters and devices for measuring permeate conductivity. FIG. 2A shows an apparatus fluidically connected to a plurality of burettes 80 for measuring weight of permeate fluid. The apparatus is placed on top of a workpiece or table 70; the burettes are located underneath the table.

In further embodiments, the invention provides apparatuses for measuring properties of two membranes during a given test cycle. In an embodiment, each membrane is associated with a permeate insert, each of which in turn is associated with either a lid or a base body. In operation, the layers of the device (e.g. lid body, permeate inserts, base body) may be stacked horizontally rather than vertically (vertical stack illustrated in FIG. 2B).

In an embodiment, the apparatus comprises
a. a lid body comprising an outer and an inner surface and a plurality of lid permeate outlets;
b. a first permeate insert comprising an outer surface and an inner surface, the inner surface of the permeate insert comprising a first cavity for receiving a first porous membrane support, the first cavity having a length and the interior surface of the first cavity further comprising a plurality of first permeate insert permeate collection ports disposed along the length of the first cavity and the outer surface of the first permeate insert comprising a plurality of first permeate insert outlets, each of the first permeate insert outlets being fluidically connected to at least one of the first permeate insert permeate collection ports; the inner surface of the lid body being in contact with the outer surface of the first permeate insert and each of the lid permeate outlets being fluidically connected to at least one of the first permeate insert outlets during testing of the membrane;
c. a base body comprising an outer surface and an inner surface and a plurality of base permeate outlets;
d. a second permeate insert comprising an outer surface and an inner surface, the inner surface of the second permeate insert comprising a second cavity for receiving a second porous support, the second cavity having a length and the interior surface of the second cavity further comprising a plurality of second permeate insert permeate collection ports disposed along the length of the second cavity and the outer surface of the second permeate insert comprising a plurality of second permeate insert outlets, each of the second permeate insert outlets being fluidically connected to at least one of the second permeate insert permeate collection outlets during testing of the membrane; the inner surface of the base body being in contact with the outer surface of the second permeate insert and each of the base permeate outlets being fluidically connected to at least one of the second permeate insert outlets during testing of the membrane;
e. a feed spacer disposed in the flow channel located between the first and the second membrane during testing of the membrane;
f. a sealing element disposed between the first and the second permeate inserts during testing of the membrane; and
g. a plurality of connecting elements for holding the lid body, first permeate insert, second permeate insert and base body in place during testing of the membrane

In an additional embodiment, the invention provides apparatuses which measure back-to-back membrane configurations with a permeate spacer therebetween. Such an embodiment is illustrated in FIGS. 3A-C. As shown in FIG. 3C, the feed outlet and feed inlet are located at the same end of the apparatus. The permeate flows out the extended portions of the permeate spacer; in FIG. 3A and the cross-section of FIG. 3C these are labeled 16a.

In an embodiment, the invention provides a cross-flow filtration membrane test apparatus comprising
a. a lid body comprising an outer and an inner surface;
b. a first feed insert comprising a first end and a second end, one of a feed inlet and a feed outlet located at the first end of the first feed insert an outer surface and an inner surface, the outer surface of the first feed insert contacting the inner surface of the lid body during testing of the membrane;
c. a first shoe insert comprising an outer surface and an inner surface, the outer surface of the first shoe insert connected to the inner surface of the first feed insert during testing of the membrane;
d. a base body comprising an outer surface and an inner surface;
e. a second feed insert comprising a first end and a second end, the other of of a feed inlet and a feed outlet located at the first end of the second feed insert, an outer surface and an inner surface, the outer surface of the second feed insert contacting the inner surface of the base body during testing of the membrane;
f. a second shoe insert comprising an outer surface and an inner surface, the outer surface of the second shoe insert connected to the inner surface of the second feed during testing of the membrane;
g. a permeate spacer having a first side and a second side, the permeate spacer being configured to receive a first membrane on the first side and a second membrane on the second side, the permeate spacer being disposed between the first shoe insert and the second shoe insert during testing of the membrane;
h. a permeate outlet fluidically connected to the permeate spacer;
i. a first sealing element disposed between the first feed insert and the permeate spacer and a second sealing element disposed between the second feed insert and the permeate spacer during testing of the membrane; and
j. a plurality of connecting elements for holding the lid body, the first feed insert, the second feed insert and the base body in place during testing of the membrane.

The apparatuses and methods of the invention are suitable for use with a variety of filtration membranes and materials known to the art. In an embodiment, the membrane is permeable to at least one component of the feed fluid. In embodiments, the filtration membrane is a microporous or nanoporous membrane. In further embodiments, the filtration membrane is a perforated two-dimensional material or perforated graphene-based material. In an embodiment, the apparatus is configured to measure properties of one membrane; exemplary apparatuses are shown in FIGS. 1A-1B and 2A-2D. In a further embodiment, the apparatus is configured to measure properties of two membranes; an exemplary apparatus is shown in FIGS. 3A-3C.

The membrane may be supported on a porous supporting material with relatively low flow resistance. The porous supporting material may also be termed a backing material. In the back-to-back membrane configuration this supporting material may be termed a permeate spacer. Suitable porous substrates can include porous polymer materials, porous metal materials, and porous ceramic materials (such as porous anodic alumina, for example), and the like.

In an embodiment, the apparatus comprises at least one feed inlet and at least one feed outlet, which are connected to a flow channel. The flow channel comprises an interior surface and may assume several configurations. In an embodiment, the feed insert forms a portion of the flow channel surface while the membrane forms another portion. In a further embodiment, a shoe insert forms a portion of the flow channel surface, while the feed insert and the membrane form other portions. In another embodiment, two membranes form opposing surfaces of the flow channel. The feed inlet and outlet may be connected to fittings via inlet and outlet assemblies, as illustrated for example in FIG. 2B (inlet assembly 30a, outlet assembly 31a).

The permeate collection ports may assume a variety of shapes. In an embodiment, each port is circular. In a further embodiment, the port may be elongated, such as a groove. One or more permeate collection ports may be connected to a well feature within the base or permeate insert.

In another aspect, the invention provides methods for measuring membrane performance. Any of the apparatus configurations described herein may be used to measure membrane performance. Apparatus configurations in which a plurality of permeate outlets are fluidically connected to permeate measurement devices are particularly suitable for use with the methods of the invention.

In an embodiment, the invention provides a method comprising the steps of:
a. laterally flowing a fluid comprising a substance across the face of a membrane; and
b. measuring the flow of a permeated fluid from a plurality of laterally disposed locations on the opposite side of the membrane.

The foregoing has outlined rather broadly the features of the present disclosure in order that the detailed description that follows can be better understood. Additional features and advantages of the disclosure will be described hereinafter. These and other advantages and features will become more apparent from the following description.

### BRIEF DESCRIPTION OF THE DRAWINGS

For a more complete understanding of the present disclosure, and the advantages thereof, reference is now made to the following descriptions to be taken in conjunction with the accompanying drawings describing specific embodiments of the disclosure, wherein:

FIG. 1A shows an illustrative schematic of a membrane evaluation apparatus of the present disclosure as assembled.

FIG. 1B shows a partial cross-sectional view of the membrane evaluation apparatus of FIG. 1A.

FIG. 2A shows an illustrative schematic of another membrane evaluation apparatus of the present disclosure as assembled and mounted on a work area. Burettes for collection of fluid are partially visible underneath the work area.

FIG. 2B shows an expansion of the active filtration testing structure of FIG. 2A;

FIGS. 2C and 2D show cross-sectional views of the membrane evaluation apparatus of FIGS. 2A and 2B; FIG. 2D is a partial view of the feed end of the apparatus.

FIG. 2E shows an illustrative schematic demonstrating how the burets of FIG. 2A are attached to the workpiece.

FIG. 3A shows an illustrative schematic of an additional membrane evaluation apparatus of the present disclosure as assembled.

FIG. 3B shows an expansion of the active filtration testing structure of FIG. 3A.

FIG. 3C shows an illustrative schematic demonstrating how a fluid can undergo cross-flow filtration in the apparatus of FIGS. 3A and 3B.

### DETAILED DESCRIPTION

The present disclosure is directed, in part, to apparatuses for evaluating the filtration properties of permeable materials and membranes, particularly under cross-flow filtration conditions. The present disclosure is also directed, in part, to methods for evaluating the filtration properties of permeable materials and other membranes, such as molecular filters and reverse osmosis membranes. Illustrative permeable materials include perforated graphene and other perforated two-dimensional materials.

As discussed above, there are not presently believed to exist membrane evaluation apparatuses that are capable of fully analyzing or otherwise quantifying the performance of permeable materials, such as perforated two-dimensional materials, particularly for evaluation of various contributory effects such as, for example, concentration polarization, feed turbulence and feed geometry parameters that occur during cross-flow filtration. As used herein, the term “cross-flow” refers to laterally passing a fluid across the face of a separation membrane; the permeate flow is generally perpendicular to the feed flow. The flow may be driven by a pressure differential. When the membrane displays different permeability to a component in the fluid than the solvent, separation of a component in the fluid can take place as the fluid passes laterally across the membrane face. As used herein, the term “concentration increase or concentration ratio increase” refers to the change in concentration of a substance in a fluid as it passes laterally along the face of a separation membrane from one end to the other. When the concentration refers to salt concentration, the term “bulk salinity rise” may also be used. As used herein, the term “concentration polarization” refers to the localized high concentration of a substance near the surface of the membrane as compared to concentrations in a direction that is normal to the membrane surface. The resulting concentrated layer at the membrane surface can increase the filter resistance and therefore reduce permeate flow through the membrane. The concentration-polarization layer thickness may vary along the channel, leading to a variation in permeate velocity along the length of the channel. In an embodiment the concentration-polarization layer increases from the feed end to the outlet end of the channel.

The inventors observed that present membrane evaluation apparatuses do not possess enough lateral length or observation capabilities to adequately measure filtration phenomena (including but not limited to bulk salinity rise, concentration polarization effects, and the like) in permeable materials and other membranes. That is, present membrane evaluation apparatuses are believed to lack sample length and are too small for incremental lateral sampling to take place during cross-flow filtration. Moreover, the inventors recognized that present membrane evaluation apparatuses do not portray a realistic simulation of operational conditions that occur in filtration, thereby not providing a true analysis of a permeable material or other membrane undergoing evaluation. That is, present membrane evaluation apparatuses do not allow a realistic determination of the properties and parameters of a particular permeable material or other membrane to take place, such as a perforated two-dimensional material. Although particular embodiments described herein may refer to two-dimensional materials, particularly perforated graphene, it is to be recognized that any permeable membrane or material can be evaluated in a like manner. In alternative embodiments, a material that is not permeable can be studied in a related manner with the described apparatuses. For example, the failure of a non-permeable membrane can be evaluated using the described apparatuses to determine when and where a membrane ruptures or otherwise fails.

In response to the foregoing needs, the present inventors have developed membrane evaluation apparatuses including two mating halves that spatially simulate the internal details of commercial membrane configurations, such as a desalination filter. Pressure balanced designs can also be implemented in some embodiments. The apparatuses described herein feature a filtration membrane support structure above a porous mechanical substrate configured to allow operation at flow rates and pressures simulating “in situ” operational conditions. Such conditions can also include scaling, fouling conditions and cleaning conditions. In addition, the apparatuses also include sampling ports linearly deployed down its length allowing periodic evaluation of cross-membrane flow and filtrate quality. The combination of these features can allow ready evaluation of physical effects, including concentration polarization, to take place under realistic operational conditions.

In more particular embodiments, the apparatuses described herein can allow a variable surface area to be tested under a variety of system configurations. Among the features that can be determined include, for example, pressure, flow rate, concentration polarization, fouling, permeate flux, and permeate flow rate per unit length/width/thickness. In addition, turbulence inducers can be added to the flow path therein so as to vary the flow channel height and volume. Moreover, the apparatuses described herein also allow a user to apply an electric field between the membrane and a conductive insert to evaluate any changes to the listed parameters above. The apparatuses described herein ultimately tie into a system level design by allowing a user to optimize performance characteristics at the filter level, thus allowing the total filtration system to be fine-tuned to the active membrane component. As described above, current membrane evaluation apparatus offerings do not allow for easy membrane scalability, flow channel height adjustment, electrification, or the ability to evaluate concentration polarization or permeate flowrate per unit length/width/height. In regard to electrification, electrical voltage or current gradients can be established laterally along the flow path along the membrane, thereby allowing the influence of electrification to be evaluated as the composition of the fluid phase changes during its lateral transit. Various voltage waveforms can also be used in this regard.

The apparatuses described herein represent a mechanical fixture that is capable of directing a test fluid laterally across a membrane when the fixture is subjected to a pressurized flow. Specifically, the fixture directs the test fluid in a cross-flow configuration over the surface of the membrane. The fixture is designed to withstand a range of pressures and flow rates that can be controlled by a feed pump. The flow channel geometry can optionally be adjusted by outfitting the fixture with an array of mechanical parts that change the relative size or shape of the feed flow and establish a regular flow pattern prior to flow reaching the active area. These parts can be tested with various industry standard turbulence inducers to optimize feed flow conditions, or custom-designed parts can be produced to modify the feed flow in a particular manner. Multiple, discrete permeate collection areas are incorporated laterally along the test fixture, being substantially perpendicular to the flow channel therein, to enable a user to evaluate the difference in membrane performance in different areas. These membrane performance differences can allow a user to measure and calculate permeate flux, concentration polarization, and permeate flow rate per unit area or length. Making these measurements and calculations can allow a user to tune filter geometries and properties for system level optimization. In addition, they can also allow a user to determine if a particular permeable material or other membrane is suitable for conducting a given filtration process. That is, the apparatuses described herein can also allow evaluation of the quality of manufacturing processes of the membrane material against predicted performance based on factors such as pore sizes, defect ratios, material quality and the like.

As discussed above, the apparatuses described herein are believed to provide a number of benefits over existing membrane filtration testing apparatuses, particularly in providing a more realistic simulation of operational conditions. Longer lengths of membranes undergoing testing in the present apparatuses can allow a user to better mimic commercial membrane offerings and more accurately see the effects of concentration polarization and determine how it changes with respect to increasing/decreasing membrane flux. The present apparatuses can be advantageous in that they can be constructed to evaluate a membrane of any desired length, including those tens of feet in length or more. Additionally, as-constructed commercial testing apparatuses that are presently available also do not offer the ability to electrify the membrane. Electrification can be used to disrupt concentration polarization, ion repulsion, and promote biofouling resistance.

Although the apparatuses herein have been described in reference to graphene and other perforated two-dimensional materials, it is to be recognized that the apparatuses can also be used in the evaluation of conventional membrane materials as well. In general, any permeable membrane or material can be tested using the apparatuses described herein. As described above, impermeable materials can also be tested in some embodiments.

The features and advantages of the apparatuses described herein will now be described with further reference to the drawings. It is to be recognized that the FIGURES presented herein only represent illustrative embodiments of the present apparatuses, and numerous alterations can be made thereto while still residing within the scope of the present disclosure. Other features can be incorporated in the drawings in accordance with the embodiments described elsewhere herein.

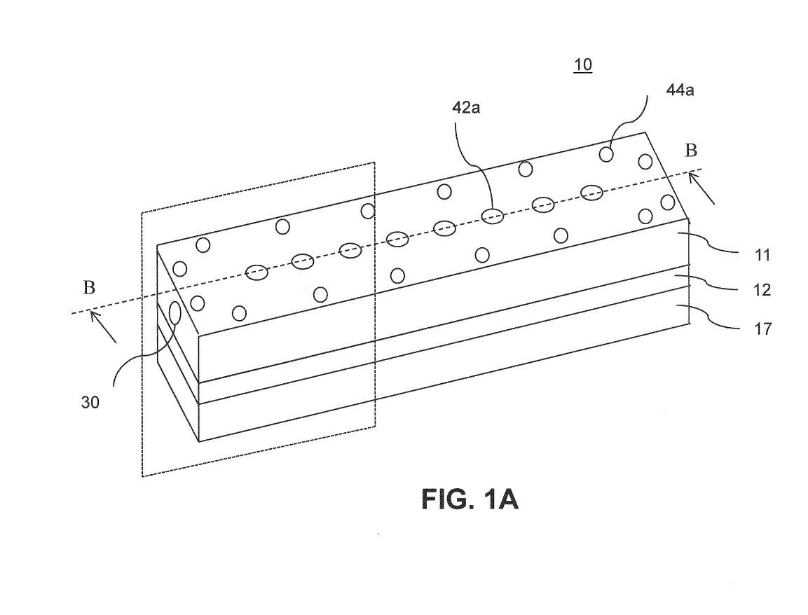

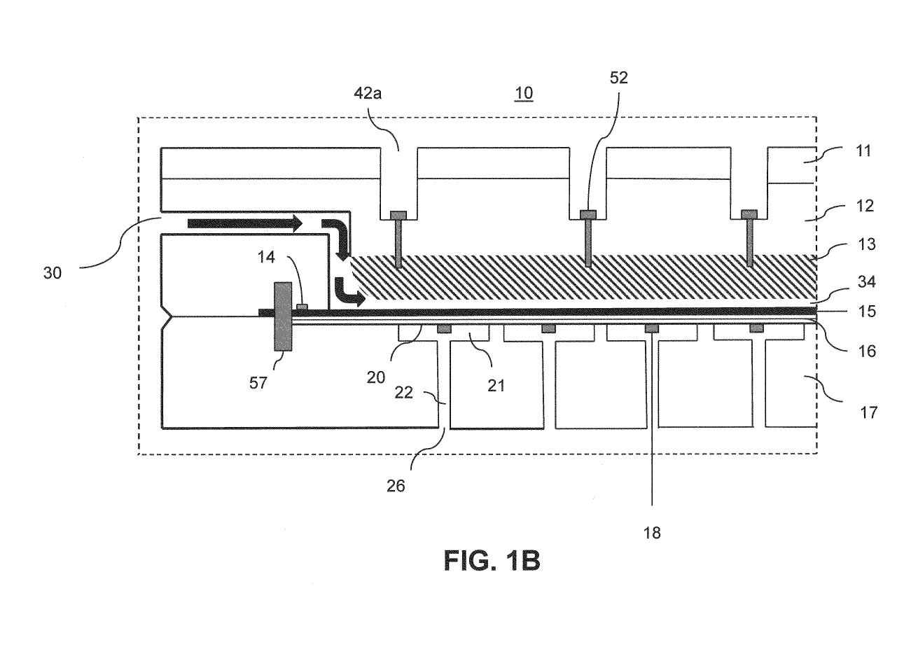

FIG. 1A shows an illustrative schematic of a membrane evaluation apparatus of the present disclosure as-assembled. FIG. 1B illustrates a partial cross-section of the membrane evaluation apparatus of FIG. 1A. As shown in FIG. 1B, the feed insert 12 and shoe insert 13 assist in establishing a lateral flow path across the membrane 15. The adjustable channel height shoe can modify the flow path to the membrane.

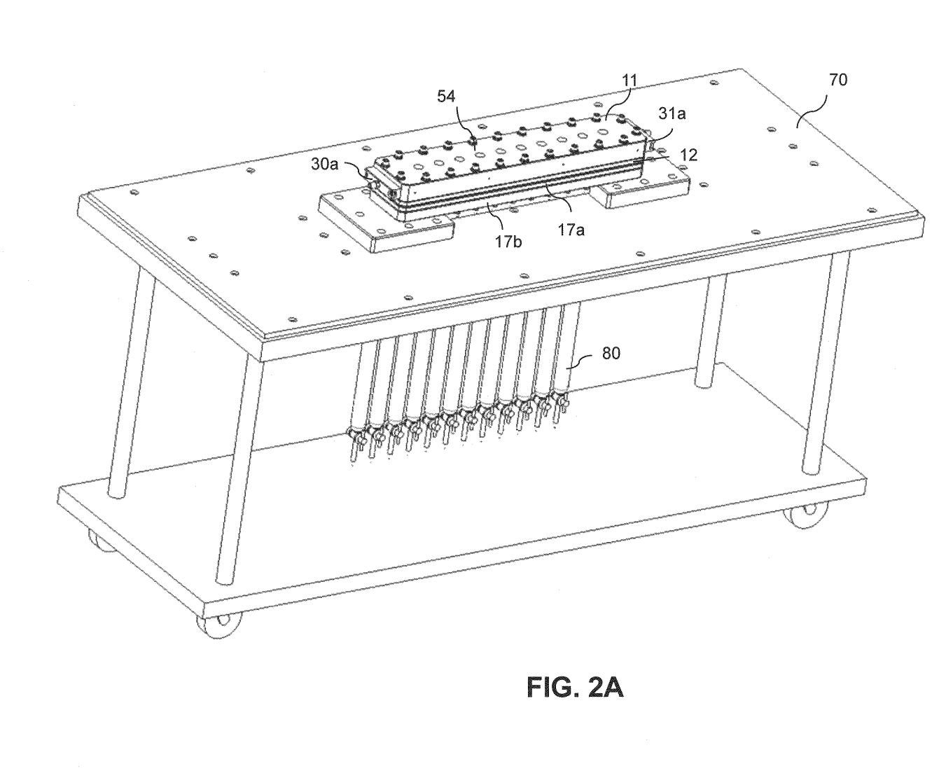

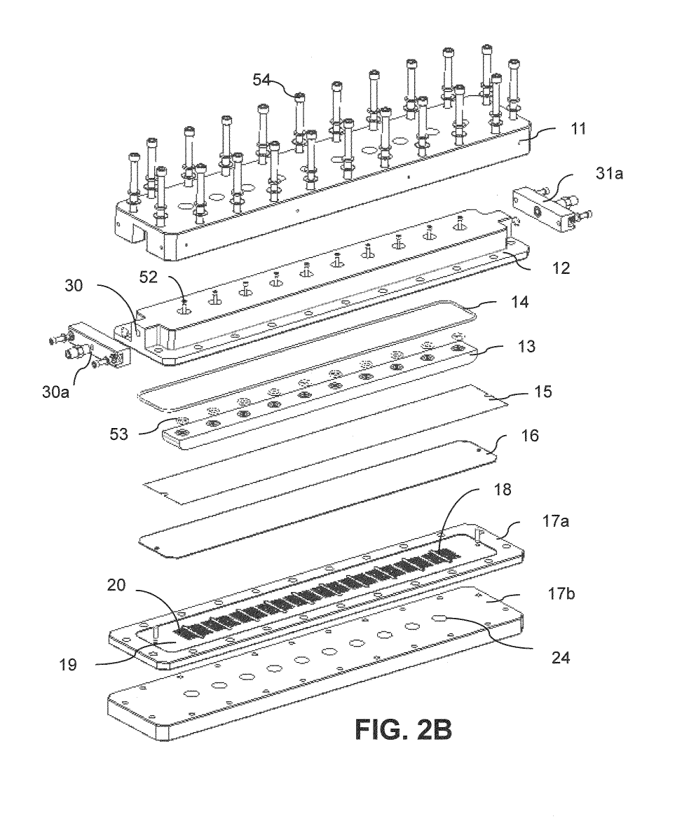

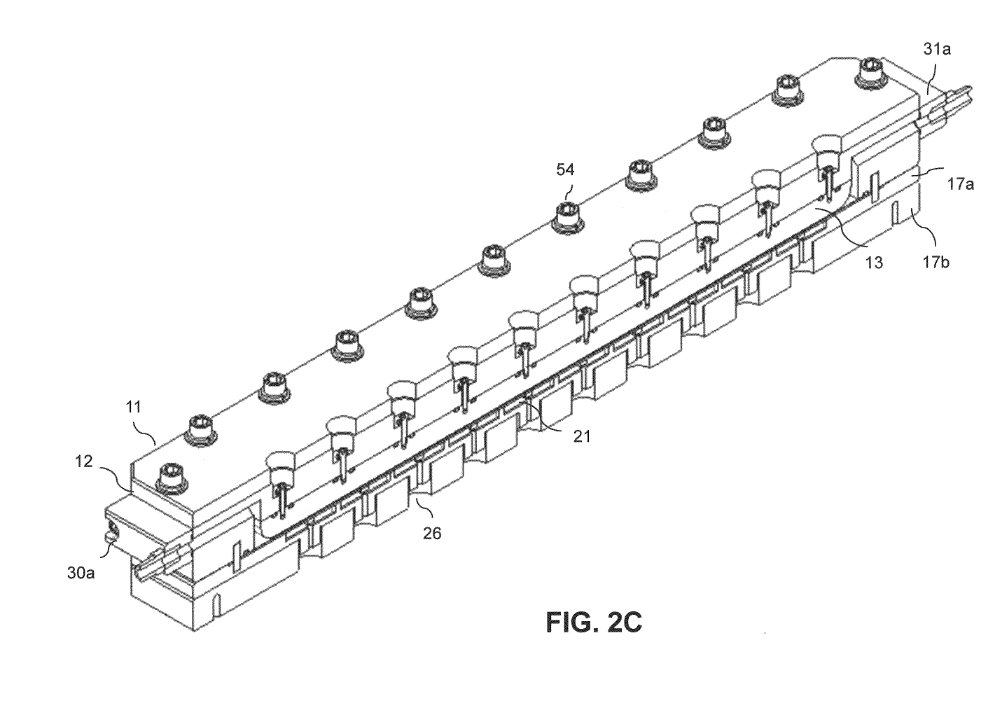

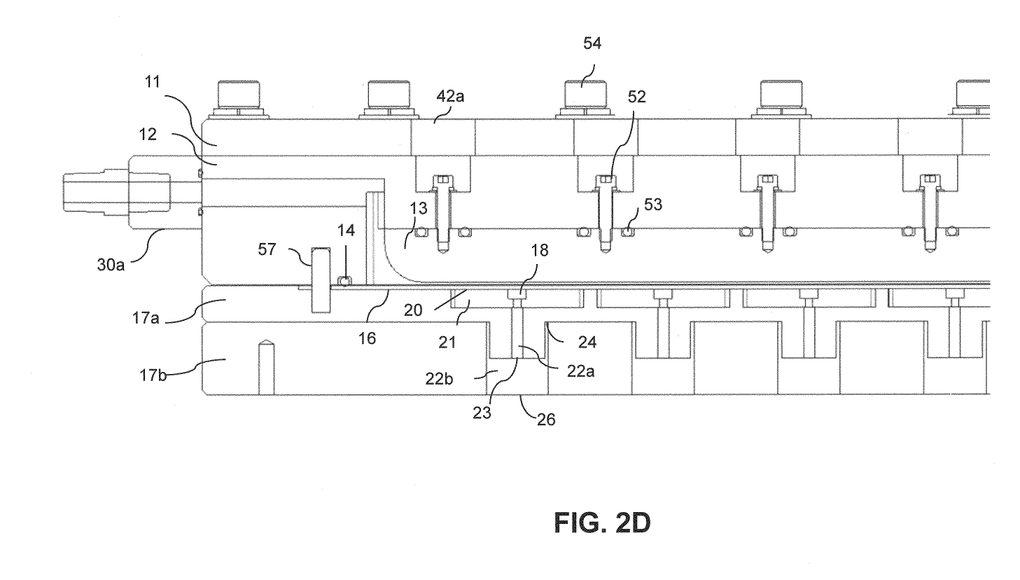

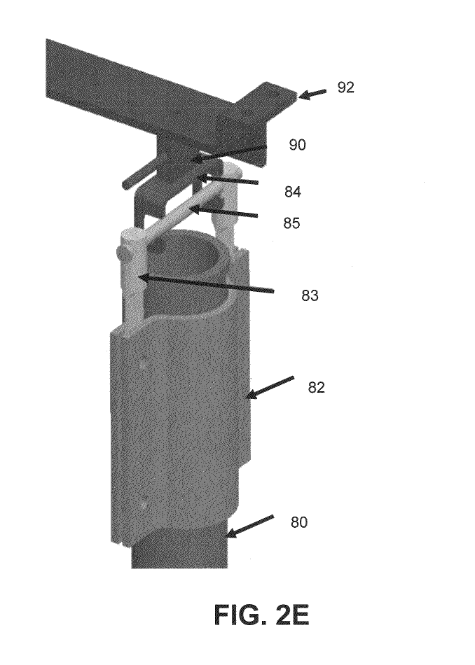

FIG. 2A shows an illustrative schematic of a membrane evaluation apparatus of the present disclosure as mounted on a work piece or table 70. The active filtration testing structure is shown in expansion in FIG. 2B and is depicted in more detail in FIGS. 2C and 2D below. Burets or other suitable collection devices are deployed below the active filtration testing structure so as to collect permeate passing through the filter membrane. Although the burets are the presently chosen means for collecting and evaluating flow, other flow measurement mechanisms, such as flow meters and permeate conductivity can be used in a similar regard. By collecting or evaluating the filtrate laterally, the significance of concentration polarization can be determined. Moreover, membrane performance as a function of lateral position can be determined. In general, any flow collection mechanism can be employed in the embodiments described herein.

FIG. 2B shows an expansion of the active filtration testing structure of FIG. 2A. As in FIG. 1A, a lid body 11, feed insert 12, shoe insert 13, membrane 15, porous membrane support 16 and O-ring 14 are present. The base portion comprises a permeate insert 17a and base body 17b. A permeate collection port 20 and supporting pin 18 have also been labeled. A plurality of central holes 24 leading to the permeate outlet are also visible on the inner surface of the base body. Openings for insertion of various connectors are also shown around the periphery of elements 11, 12, 17a, and 17b and centrally in elements 11, 12 and 13. A feed inlet assembly 30a and feed outlet assembly 31a are also shown. The permeate collection ports feed the burets shown in FIG. 2A.

FIG. 2D, a cross-sectional view of a feed end of the apparatus, further illustrates the connectors 52 which connect the shoe insert 13 to the feed insert 12 and associated O-rings 53. The connectors 54 on the periphery which connect the lid body, feed insert, permeate insert and base body are also shown. Also labeled in FIG. 2D is the permeate insert conduit 22a; in this embodiment, the conduit connects the permeate well 21 to the permeate outlet 23. More generally a permeate conduit 22a may connect the permeate collection port to the permeate insert outlet 23 or a permeate conduit 22 may connect the permeate collection port or permeate well to the permeate outlet 26. Similarly, base body permeate conduit 22b extends inwards from the permeate outlet 26 towards base body inlet 24.

FIG. 2E shows an illustrative schematic demonstrating an embodiment of how the burets of FIG. 2A are attached to the apparatus. As shown in FIG. 2E, each burette 80 may be hung from hanger 85, with the hanger 85 being connected to a weight sensor 90 which is in turn connected to sensor support 92. The sensor support may be attached to the underside of the table 70. A clamp 82 holds the burette and is connected to vertical bar 83, which in turn is connected to horizontal crossbeam 84.

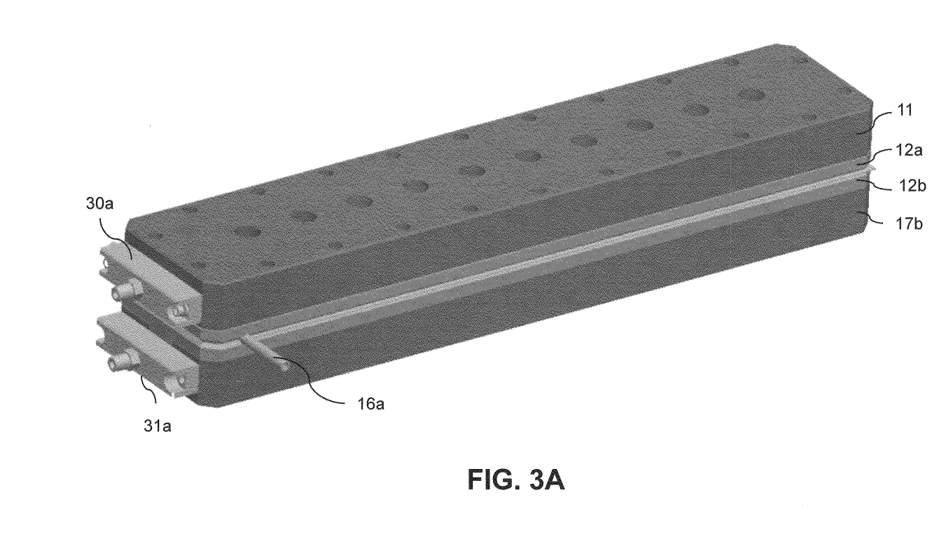

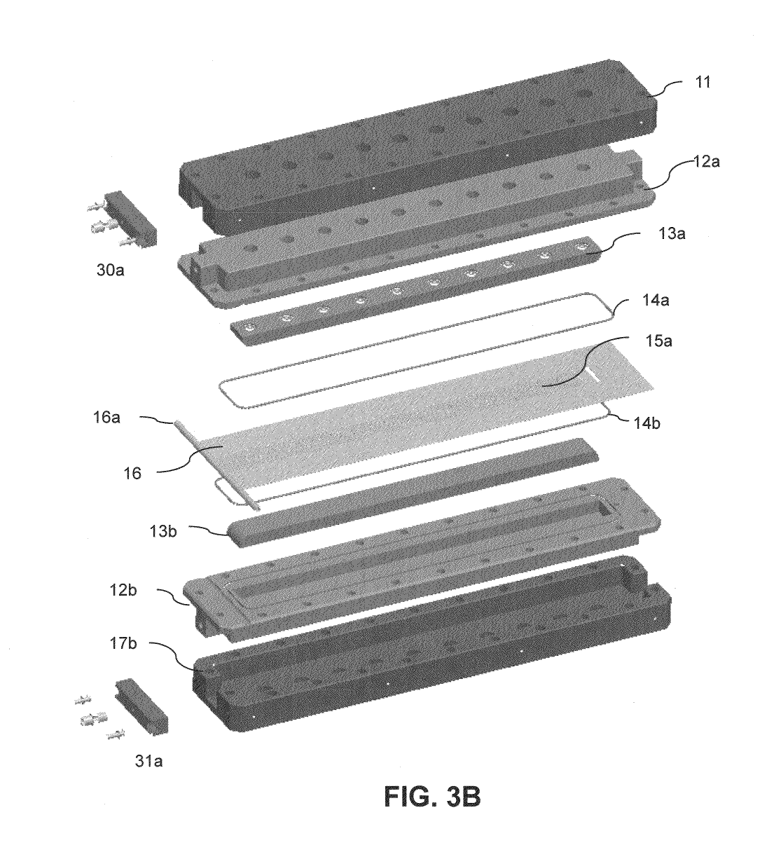

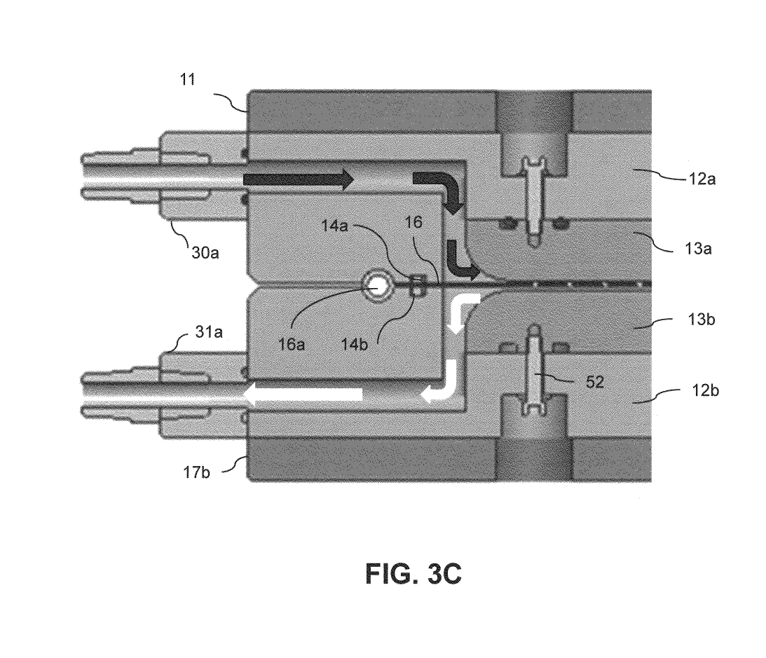

FIGS. 3A-3C illustrate an embodiment in which back-to-back membranes are located on a single permeate spacer. One membrane is on each side of the permeate spacer 16, only the top membrane 15a is visible in FIG. 3B. The permeate flows out the extended portions of the permeate spacer 16a; in the cross-section of FIG. 3C these appear as a circle. There are two feed inserts (12a, 12b), two shoe inserts (13a, 13b) and two sealing elements (14a, 14b). As shown in FIGS. 3B and 3C, the feed outlet and feed inlet are located at the same end of the apparatus and flow; a gap in the permeate spacer near the other end of the apparatus allows the feed stream to access the lower membrane. In an alternate embodiment the shoe inserts are omitted.

Although certain portions of the description herein refer to graphene membranes, it is to be recognized that any suitable two-dimensional material or other filtration membrane can be used and tested in a like manner. A variety of two-dimensional materials useful in the present invention are known in the art. In various embodiments, the two-dimensional material comprises graphene, molybdenum sulfide, or boron nitride. In an embodiment, the two-dimensional material is a graphene-based material. In more particular embodiments, the two-dimensional material is graphene. Graphene according to the embodiments of the present disclosure can include single-layer graphene, multi-layer graphene, or any combination thereof. Other nanomaterials having an extended two-dimensional molecular structure can also constitute the two-dimensional material in the various embodiments of the present disclosure. For example, molybdenum sulfide is a representative chalcogenide having a two-dimensional molecular structure, and other various chalcogenides can constitute the two-dimensional material in the embodiments of the present disclosure. Choice of a suitable two-dimensional material for a particular application can be determined by a number of factors, including the chemical and physical environment into which the graphene or other two-dimensional material is to be terminally deployed.

In an embodiment, the two dimensional material useful in membranes herein is a sheet of graphene-based material. Graphene-based materials include, but are not limited to, single layer graphene, multilayer graphene or interconnected single or multilayer graphene domains and combinations thereof. In an embodiment, graphene-based materials also include materials which have been formed by stacking single or multilayer graphene sheets. In embodiments, multilayer graphene includes 2 to 20 layers, 2 to 10 layers or 2 to 5 layers. In embodiments, graphene is the dominant material in a graphene-based material. For example, a graphene-based material comprises at least 30% graphene, or at least 40% graphene, or at least 50% graphene, or at least 60% graphene, or at least 70% graphene, or at least 80% graphene, or at least 90% graphene, or at least 95% graphene. In embodiments, a graphene-based material comprises a range of graphene selected from 30% to 95%, or from 40% to 80% from 50% to 70%, from 60% to 95% or from 75% to 100%.

As used herein, a “domain” refers to a region of a material where atoms are uniformly ordered into a crystal lattice, A domain is uniform within its boundaries, but different from a neighboring region. For example, a single crystalline material has a single domain of ordered atoms. In an embodiment, at least some of the graphene domains are nanocrystals, having a domain size from 1 to 100 nm or 10-100 nm. In an embodiment, at least some of the graphene domains have a domain size greater than 100 nm to 1 micron, or from 200 nm to 800 nm, or from 300 nm to 500 nm. “Grain boundaries” formed by crystallographic defects at edges of each domain differentiate between neighboring crystal lattices. In some embodiments, a first crystal lattice may be rotated relative to a second crystal lattice, by rotation about an axis perpendicular to the plane of a sheet, such that the two lattices differ in “crystal lattice orientation”.

In an embodiment, the sheet of graphene-based material comprises a sheet of single or multilayer graphene or a combination thereof. In an embodiment, the sheet of graphene-based material is a sheet of single or multilayer graphene or a combination thereof. In another embodiment, the sheet of graphene-based material is a sheet comprising a plurality of interconnected single or multilayer graphene domains. In an embodiment, the interconnected domains are covalently bonded together to form the sheet. When the domains in a sheet differ in crystal lattice orientation, the sheet is polycrystalline.

In embodiments, the thickness of the sheet of graphene-based material is from 0.34 to 10 nm, from 0.34 to 5 nm, or from 0.34 to 3 nm. In an embodiment, a sheet of graphene-based material comprises intrinsic defects. Intrinsic defects are those resulting from preparation of the graphene-based material in contrast to perforations which are selectively introduced into a sheet of graphene-based material or a sheet of graphene. Such intrinsic defects include, but are not limited to, lattice anomalies, pores, tears, cracks or wrinkles. Lattice anomalies can include, but are not limited to, carbon rings with other than 6 members (e.g. 5, 7 or 9 membered rings), vacancies, interstitial defects (including incorporation of non-carbon atoms in the lattice), and grain boundaries.

In an embodiment, membrane comprising the sheet of graphene-based material further comprises non-graphenic carbon-based material located on the surface of the sheet of graphene-based material. In an embodiment, the non-graphenic carbon-based material does not possess long range order and may be classified as amorphous. In embodiments, the non-graphenic carbon-based material further comprises elements other than carbon and/or hydrocarbons. Non-carbon elements which may be incorporated in the non-graphenic carbon include, but are not limited to, hydrogen, oxygen, silicon, copper and iron. In embodiments, the non-graphenic carbon-based material comprises hydrocarbons. In embodiments, carbon is the dominant material in non-graphenic carbon-based material. For example, a non-graphenic carbon-based material comprises at least 30% carbon, or at least 40% carbon, or at least 50% carbon, or at least 60% carbon, or at least 70% carbon, or at least 80% carbon, or at least 90% carbon, or at least 95% carbon. In embodiments, a non-graphenic carbon-based material comprises a range of carbon selected from 30% to 95%, or from 40% to 80%, or from 50% to 70%.

Two-dimensional materials in which pores are intentionally created are referred to herein as “perforated”, such as “perforated graphene-based materials”, “perforated two-dimensional materials” or “perforated graphene.” Two-dimensional materials are, most generally, those which have atomically thin thickness from single-layer sub-nanometer thickness to a few nanometers and which generally have a high surface area. Two-dimensional materials include metal chalcogenides (e.g., transition metal dichalcogenides), transition metal oxides, hexagonal boron nitride, graphene, silicene and germanene (see: Xu et al. (2013) “Graphene-like Two-Dimensional Materials) Chemical Reviews 113:3766-3798).

Two-dimensional materials include graphene, a graphene-based material, a transition metal dichalcogenide, molybdenum sulfide, a-boron nitride, silicene, germanene, or a combination thereof. Other nanomaterials having an extended two-dimensional, planar molecular structure can also constitute the two-dimensional material in the various embodiments of the present disclosure. For example, molybdenum sulfide is a representative chalcogenide having a two-dimensional molecular structure, and other various chalcogenides can constitute the two-dimensional material in embodiments of the present disclosure. In another example, two-dimensional boron nitride can constitute the two-dimensional material in an embodiment of the invention. Choice of a suitable two-dimensional material for a particular application can be determined by a number of factors, including the chemical and physical environment into which the graphene, graphene-based or other two-dimensional material is to be deployed.

In embodiments, perforated graphene, perforated graphene-based materials and other perforated two-dimensional materials containing a plurality of apertures (or holes) ranging from about 3 to 15 angstroms in size. In a further embodiment, the hole size ranges from 3 to 10 angstroms or from 3 to 6 angstroms in size. The present disclosure is further directed, in part, to perforated graphene, perforated graphene-based materials and other perforated two-dimensional materials containing a plurality of holes ranging from about 3 to 15 angstrom in size and having a narrow size distribution, including but not limited to a 1-10% deviation in size or a 1-20% deviation in size. In an embodiment, the characteristic dimension of the holes is from about 3 to 15 angstroms in size.

The present disclosure is also directed, in part, to perforated graphene, perforated graphene-based materials and other perforated two-dimensional materials containing a plurality of apertures (or holes) ranging from about 5 to about 1000 angstroms in size. In further embodiments, the apertures range from 10 to 100 angstroms, 10 to 50 angstroms 10 to 20 angstroms or 5 to 20 angstroms. In a further embodiment, the hole size ranges from 100 nm up to 1000 nm or from 100 nm to 500 nm. The present disclosure is further directed, in part, to perforated graphene, perforated graphene-based materials and other perforated two-dimensional materials containing a plurality of holes ranging from about 5 to 1000 angstrom in size and having a narrow size distribution, including but not limited to a 1-10% deviation in size or a 1-20% deviation in size. In an embodiment, the characteristic dimension of the holes is from 5 to 1000 angstrom.

For circular holes, the characteristic dimension is the diameter of the hole. In embodiments relevant to non-circular pores, the characteristic dimension can be taken as the largest distance spanning the hole, the smallest distance spanning the hole, the average of the largest and smallest distance spanning the hole, or an equivalent diameter based on the in-plane area of the pore. As used herein, perforated graphene-based materials include materials in which non-carbon atoms have been incorporated at the edges of the pores.

In the drawings, like elements are indicated with like reference numbers.

Although the disclosure has been described with reference to the disclosed embodiments, one having ordinary skill in the art will readily appreciate that these are only illustrative of the disclosure. It should be understood that various modifications can be made without departing from the spirit of the disclosure. The disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that aspects of the disclosure may include only some of the described embodiments. Accordingly, the disclosure is not to be seen as limited by the foregoing description.

Every formulation or combination of components described or exemplified can be used to practice the invention, unless otherwise stated. Specific names of compounds are intended to be exemplary, as it is known that one of ordinary skill in the art can name the same compounds differently. When a compound is described herein such that a particular isomer or enantiomer of the compound is not specified, for example, in a formula or in a chemical name, that description is intended to include each isomers and enantiomer of the compound described individual or in any combination. One of ordinary skill in the art will appreciate that methods, device elements, starting materials and synthetic methods other than those specifically exemplified can be employed in the practice of the invention without resort to undue experimentation. All art-known functional equivalents, of any such methods, device elements, starting materials and synthetic methods are intended to be included in this invention. Whenever a range is given in the specification, for example, a temperature range, a time range, or a composition range, all intermediate ranges and subranges, as well as all individual values included in the ranges given are intended to be included in the disclosure. When a Markush group or other grouping is used herein, all individual members of the group and all combinations and subcombinations possible of the group are intended to be individually included in the disclo sure.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements. The invention illustratively described herein suitably may be practiced in the absence of any element or elements, limitation or limitations which is not specifically disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

In general the terms and phrases used herein have their art-recognized meaning, which can be found by reference to standard texts, journal references and contexts known to those skilled in the art. The preceding definitions are provided to clarify their specific use in the context of the invention.

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

All patents and publications mentioned in the specification are indicative of the levels of skill of those skilled in the art to which the invention pertains. References cited herein are incorporated by reference herein in their entirety to indicate the state of the art, in some cases as of their filing date, and it is intended that this information can be employed herein, if needed, to exclude (for example, to disclaim) specific embodiments that are in the prior art. For example, when a compound is claimed, it should be understood that compounds known in the prior art, including certain compounds disclosed in the references disclosed herein (particularly in referenced patent documents), are not intended to be included in the claim.

What is claimed is the following:

1. A cross-flow filtration membrane test apparatus for testing at least one membrane, the apparatus comprising a membrane support, a feed inlet, a feed outlet, a plurality of permeate collection ports and a plurality of permeate outlets, each permeate outlet being fluidically connected to at least one permeate collection port
wherein the apparatus is configured to form a flow channel during testing of the membrane such that a first face of the membrane comprises a portion of the surface of the flow channel over a length of the membrane, the flow channel being fluidically connected to the feed inlet and the feed outlet and wherein the apparatus is configured so that the permeate collection ports are disposed along the length of the membrane and on the same side as a second face of the membrane during testing of the membrane.

2. The apparatus of claim 1, wherein the length of the membrane is from 0.30 m to 5 m.

3. The apparatus of claim 2, wherein the length of the membrane is from 0.45 m to 1 m.

4. The apparatus of claim 1, wherein the number of permeate outlets is an integer from 2 to 100.

5. The apparatus of claim 1, wherein the number of permeate collection ports fluidically connected to each of the permeate outlets is an integer from 1 to 10.

6. The apparatus of claim 5, wherein the number of permeate collection ports fluidically connected to each of the permeate outlets is an integer from 5 to 10.

7. The apparatus of claim 1, wherein each of the permeate outlets is fluidically connected to a permeate measurement device.

8. The cross-flow filtration membrane test apparatus of claim 1 wherein the apparatus further comprises
a. a lid body comprising an outer and an inner surface;
b. a feed insert comprising a first end and a second end, the feed inlet being located at the first end of the feed insert, the feed outlet being located at the second end of the feed insert, an outer surface and an inner surface, the outer surface of the feed insert contacting the inner surface of the lid body during testing of the membrane;
c. a shoe insert comprising an outer surface and an inner surface, the outer surface of the shoe insert connected to the inner surface of the feed insert during testing of the membrane and the inner surface of the shoe insert forming a portion of the surface of the flow channel during testing of the membrane;
d. a base comprising an outer surface and an inner surface, the inner surface of the base comprising a cavity for receiving a porous membrane support the cavity having a length and the interior surface of the cavity further comprising the plurality of permeate collection ports disposed along the length of the cavity, and the base further comprising the plurality of permeate outlets;
e. a sealing element disposed between the feed insert and the base during testing of the membrane; and
f. a plurality of connecting elements for holding the lid body, the feed insert and the base in place during testing of the membrane.

9. The apparatus of claim 8, wherein the base further comprises
a. a permeate insert comprising an outer surface and an inner surface, the inner surface of the permeate insert comprising the cavity for receiving the porous support, and the outer surface of the permeate insert comprising a plurality of permeate insert outlets, each of permeate insert outlets being fluidically connected to at least one of the permeate collection ports during testing of the membrane; and
b. a base body comprising an outer surface and an inner surface and the permeate outlets, the inner surface of the base body being in contact with to the outer surface of the permeate insert and each of the permeate outlets being fluidically connected to at least one of the permeate insert outlets during testing of the membrane;
wherein the sealing element is disposed between the feed insert and the permeate insert.

10. The apparatus of claim 9, wherein the shoe insert and the membrane are electrically conducting, the permeate insert and the feed insert are electrically insulating and the apparatus further comprises a first electrical contact to the shoe insert and a second electrical contact to the membrane.

11. The cross-flow filtration membrane test apparatus of claim 1 for testing two membranes, wherein the apparatus further comprises
a. a lid body comprising an outer and an inner surface and a plurality of lid permeate outlets;
b. a first permeate insert comprising an outer surface and an inner surface, the inner surface of the permeate insert comprising a first cavity for receiving a first porous membrane support, the first cavity having a length and the interior surface of the first cavity further comprising a plurality of first permeate insert permeate collection ports disposed along the length of the first cavity and the outer surface of the first permeate insert comprising a plurality of first permeate insert outlets, each of the first permeate insert outlets being fluidically connected to at least one of the first permeate insert permeate collection ports; the inner surface of the lid body being in contact with the outer surface of the first permeate insert and each of the lid permeate outlets being fluidically connected to at least one of the first permeate insert outlets during testing of the membrane;
c. a base body comprising an outer surface and an inner surface and a plurality of base permeate outlets;
d. a second permeate insert comprising an outer surface and an inner surface, the inner surface of the second permeate insert comprising a second cavity for receiving a second porous support, the second cavity having a length and the interior surface of the second cavity further comprising a plurality of second permeate insert permeate collection ports disposed along the length of the second cavity and the outer surface of the second permeate insert comprising a plurality of second permeate insert outlets, each of the second permeate insert outlets being fluidically connected to at least one of the second permeate insert permeate collection outlets during testing of the membrane; the inner surface of the base body being in contact with the outer surface of the second permeate insert and each of the base permeate outlets being fluidically connected to at least one of the second permeate insert outlets during testing of the membrane;
e. a feed spacer disposed in the flow channel located between the first and the second membrane during testing of the membrane;
f. a sealing element disposed between the first and the second permeate inserts during testing of the membrane; and
g. a plurality of connecting elements for holding the lid body, first permeate insert, second permeate insert and base body in place during testing of the membrane.

12. The membrane of claim 11, wherein the first and second membrane are electrically conducting and the apparatus further comprises a first electrical contact to the first membrane and a second electrical contact to the second membrane.

13. A cross-flow filtration membrane test apparatus comprising
a. a lid body comprising an outer and an inner surface;
b. feed inlet and a feed outlet;
c. a first feed insert comprising a first end and a second end, an outer surface and an inner surface, the outer surface of the first feed insert contacting the inner surface of the lid body during testing of the membrane and one of the feed inlet and the feed outlet being located at the first end of the first feed inlet;
d. a first shoe insert comprising an outer surface and an inner surface, the outer surface of the first shoe insert connected to the inner surface of the first feed insert during testing of the membrane;
e. a base body comprising an outer surface and an inner surface;
f. a second feed insert comprising a first end and a second end, an outer surface and an inner surface, the outer surface of the second feed insert contacting the inner surface of the base body during testing of the membrane and the other of the feed inlet and the feed outlet being located at the first end of the second feed insert;
g. a second shoe insert comprising an outer surface and an inner surface, the outer surface of the second shoe insert connected to the inner surface of the second feed insert during testing of the membrane;
h. a permeate spacer having a first side and a second side, the permeate spacer being configured to receive a first membrane on the first side and a second membrane on the second side, the permeate spacer being disposed between the first shoe insert and the second shoe insert during testing of the membrane;
i. a permeate outlet fluidically connected to the permeate spacer;
j. a first sealing element disposed between the first feed insert and the permeate spacer and a second sealing element disposed between the second feed insert and the permeate spacer during testing of the membrane; and
k. a plurality of connecting elements for holding the lid body, the first feed insert, the second feed insert and the base body in place during testing of the membrane.

14. The apparatus of claim 13, wherein the length of each of the first cavity and the second cavity is from 0.30 m to 5 m.

15. The apparatus of claim 14, wherein the length of each of the first cavity and the second cavity is from 0.45 m to 1 m.

16. The apparatus of claim 13, wherein the first and second shoe inserts and the first and second membranes are electrically conducting, the permeate spacer and the first and second feed insert are electrically insulating and the apparatus further comprises a first electrical contact to the first shoe insert, a second electrical contact to the first membrane a third electrical contact to the second shoe insert and a fourth electrical contact to the second membrane.

17. A method comprising the steps of:
a. laterally flowing a fluid comprising a substance across the face of a membrane; and
b. measuring the flow of a permeated fluid from a plurality of laterally disposed locations on the opposite side of the membrane.

18. The method of claim 17, wherein the flow is measured by measuring the weight of permeated fluid collected over time from each of the laterally disposed locations.

19. The method of claim 17, wherein the flow is measured using a flow meter to measure the flow of fluid collected from each of the laterally disposed locations.

20. The method of claim 17, wherein the membrane is a perforated two dimensional material.

21. The method of claim 17, wherein the membrane is a perforated graphene-based material.

22. The method of claim 17, wherein the fluid is provided to the feed inlet of a cross-flow filtration membrane test apparatus, the apparatus further comprising a membrane support, a feed outlet, a plurality of permeate collection ports and a plurality of permeate outlets, each permeate outlet being fluidically connected to at least one permeate collection port and wherein the flow of permeated fluid is measured from the permeate outlets.
